(19) United States
(12) Patent Application Publication
(10) Pub. No.: US 2017/0339252 A1
(43) Pub. Date: Nov. 23, 2017

(54) GENERATING A RESPONSE TO A CLIENT DEVICE IN AN INTERNET OF THINGS DOMAIN

(71) Applicant: HEWLETT PACKARD ENTERPRISE DEVELOPMENT LP, Houston, TX (US)

(72) Inventor: Hugh Hamill, Galway (IE)

(21) Appl. No.: 15/156,509

(22) Filed: May 17, 2016

(51) Int. Cl. H04L 29/06; H04L 29/08

(52) U.S. Cl. CPC H04L 67/42; H04L 67/02

(57) ABSTRACT

The present disclosure relates to a method and device to generate a response to a client device in an IoT domain. The disclosed computing device can receive a request from a client device to retrieve information from an Internet of Things (IoT) Application Programming Interface (API), and request a plurality of objects in a domain from the IoT API. Then, the computing device extracts a plurality of names corresponding to the plurality of objects, and pluralizes each of the plurality of names corresponding to the plurality of objects. Next, the computing device generates a link for each pluralized name. Further, the computing device generates a response to the client device by embedding the link for each pluralized name.

### BACKGROUND

A generic Internet of Things (IoT) model generally contains the following blocks: ThingType, which describes a class model for defining IoT classes and attributes; ThingformationType, which describes a class model for defining IoT messaging classes and attributes; RelationshipType, which describes a class model for defining IoT inter-Thing or inter-Thingformation relationships; Thing, which describes an instance model for IoT object instances; Thingformation, which describes an instance model for IoT messaging instances; and Relationship, which describes an instance model for IoT relationship instances. Such generic IoT model does not provide domain-specific representational state transfer (REST) application programming interface (API). Therefore, it is difficult for client developers and client applications to work with the generic IoT model.

### BRIEF DESCRIPTION OF THE DRAWINGS

The following detailed description references the drawings, wherein:

FIG. 1 is a block diagram of an example environment for an IoT model in which a domain-specific REST controller is deployed;

FIG. 2 is a block diagram of an example response generation using the domain-specific REST controller;

FIGS. 3A-3C show example attributes from generic responses extracted by the domain-specific REST controller;

FIG. 4 shows an example response generated by the domain-specific REST controller;

FIG. 5 is a block diagram of an example generation of response including individual resource representations using the domain-specific REST controller;

FIG. 6A shows example attributes from generic responses corresponding to a Thing as extracted by the domain-specific REST controller;

FIG. 6B shows example attributes from generic responses corresponding to a Thingformation as extracted by the domain-specific REST controller;

FIG. 7A shows an example response including dynamically generated attributes and link to a Thing as generated by the domain-specific REST controller;

FIG. 7B shows an example response including dynamically generated attributes and link to a Thingformation as generated by the domain-specific REST controller;

FIG. 8 is a block diagram of an example generation of response including resource links for related thingformations using the domain-specific REST controller;

FIGS. 9A-9D show example responses illustrating dynamic generation of resource links for related thingformations using the domain-specific REST controller;

FIG. 10 is a block diagram of an example generation of response including resource links for related things using the domain-specific REST controller;

FIGS. 11A-11D show example responses illustrating dynamic generation of resource links for related things using the domain-specific REST controller;

FIG. 12 is a block diagram of an example generation of response including resource links for nested resources using the domain-specific REST controller;

FIGS. 13A-13C show example responses illustrating dynamic generation of resource links for nested resources using the domain-specific REST controller;

FIG. 14 is a flowchart of an example process to generate a response to a client device in an IoT domain;

FIG. 15 is a flowchart of an example process to generate a response to a client device in an IoT domain;

FIG. 16 is a flowchart of an example process to generate a response to a client device in an IoT domain; and

FIG. 17 is a block diagram of an example network device to generate a response to a client device in an IoT domain.

### DETAILED DESCRIPTION

Given the generic IoT model, a domain-specific controller according to the present disclosure will dynamically serve this model in a domain-specific REST API. It will expose a collection of resource endpoints encoded using the Hypertext Application Language (HAL) format at the root (‘/’) of the REST API, which are based on the pluralized names of the ThingType objects defined in the IoT model. The disclosed domain-specific controller also transforms and exposes both Things and Thingformation as domain-specific individual and collection resource representations with attributes and Hypermedia as the Engine of Application State (HATEOAS) links. It will generate HATEOAS Links in a given resource to domain-specific message collection endpoints or related resource individual or collection endpoints using domain-specific Rels for Thingformation message types in the IoT domain. Changes in the underlying IoT domain are immediately reflected by the domain-specific controller to interacting client code, without restarting the domain-specific API application or incurring any downtime.

Overview

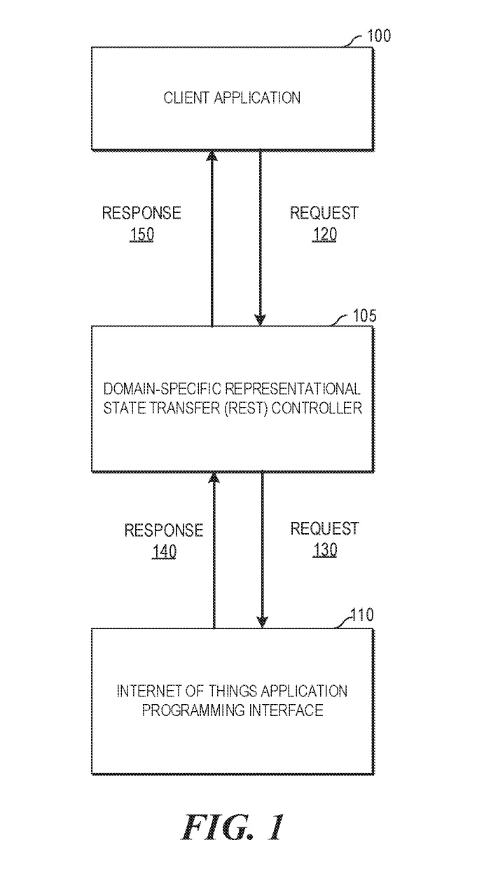

FIG. 1 shows a block diagram of an example environment for an IoT model, in which a domain-specific REST controller is deployed. In FIG. 1, Client Application 100 makes a request 120 to a domain-specific REST controller 105. Domain-specific REST controller 105 then interacts with a generic Internet of Things (IoT) API 110 to produce a response for an IoT client. Specifically, domain-specific REST controller 105 sends a request 130 to IoT API 110 and receives a generic response (e.g., response 140) from IoT API 110. Then, domain-specific REST controller 105 generates a domain-specific response (e.g., response 150) based on the generic response (e.g., response 140) received from IoT API 110. Note that in some cases, domain-specific REST controller 105 may send multiple requests (e.g., multiple requests 130) to IoT API 110 and receive multiple responses (e.g., responses 140) in order to generate a response (e.g., response 150) to a request (e.g., request 120) received from client application 100.

As used throughout this disclosure, “ThingType” generally describes a class model for defining IoT classes and attributes; “ThingformationType” generally describes a class model for defining IoT messaging classes and attributes; “RelationshipType” generally describes a class model for defining IoT inter-Thing or inter-Thingformation relationships; “Thing” generally describes an instance model for IoT object instances; “Thingformation” generally describes an instance model for IoT messaging instances; and “Relationship” generally describes an instance model for IoT relationship instances.

Entry Points

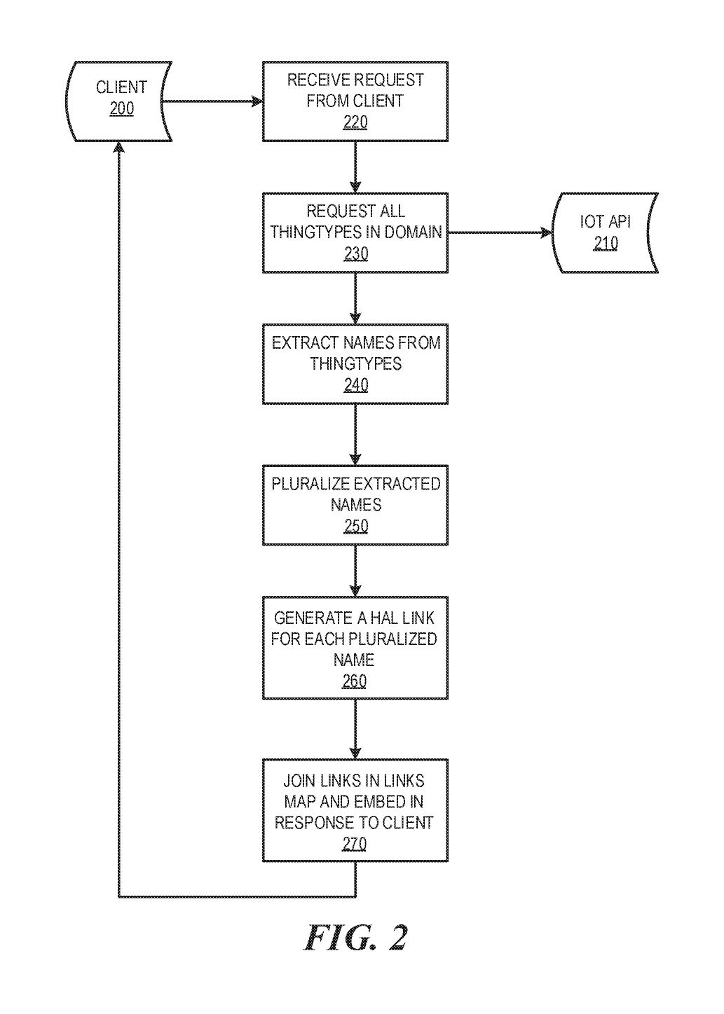

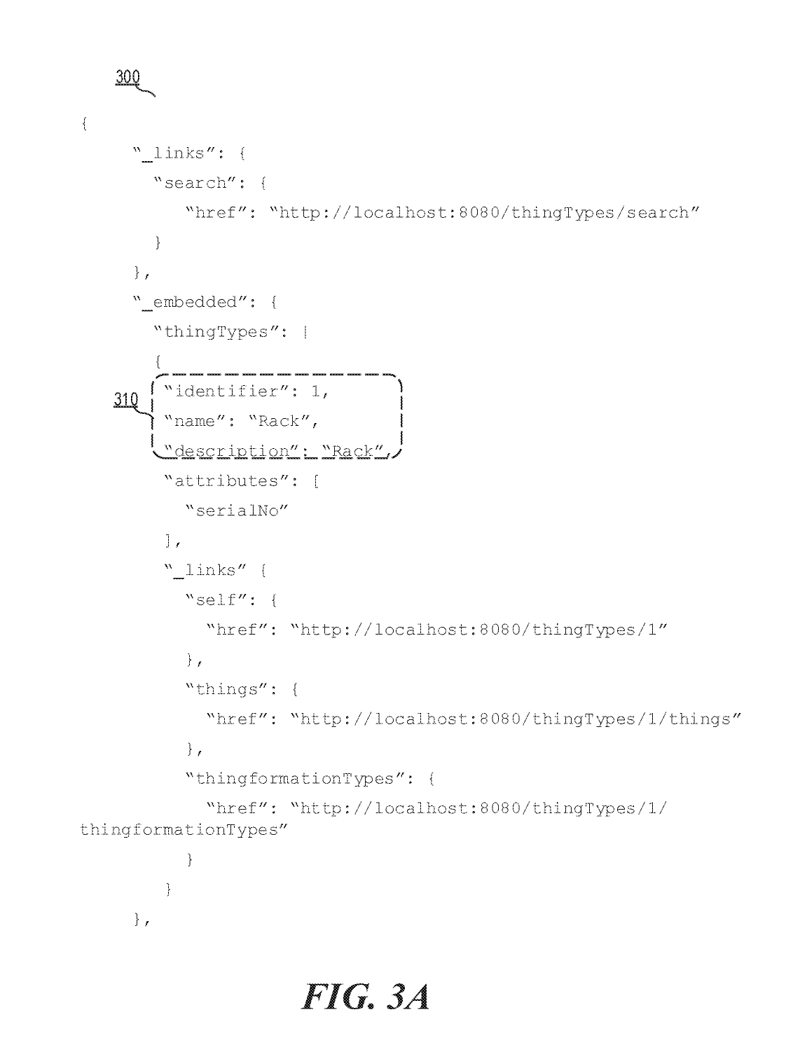

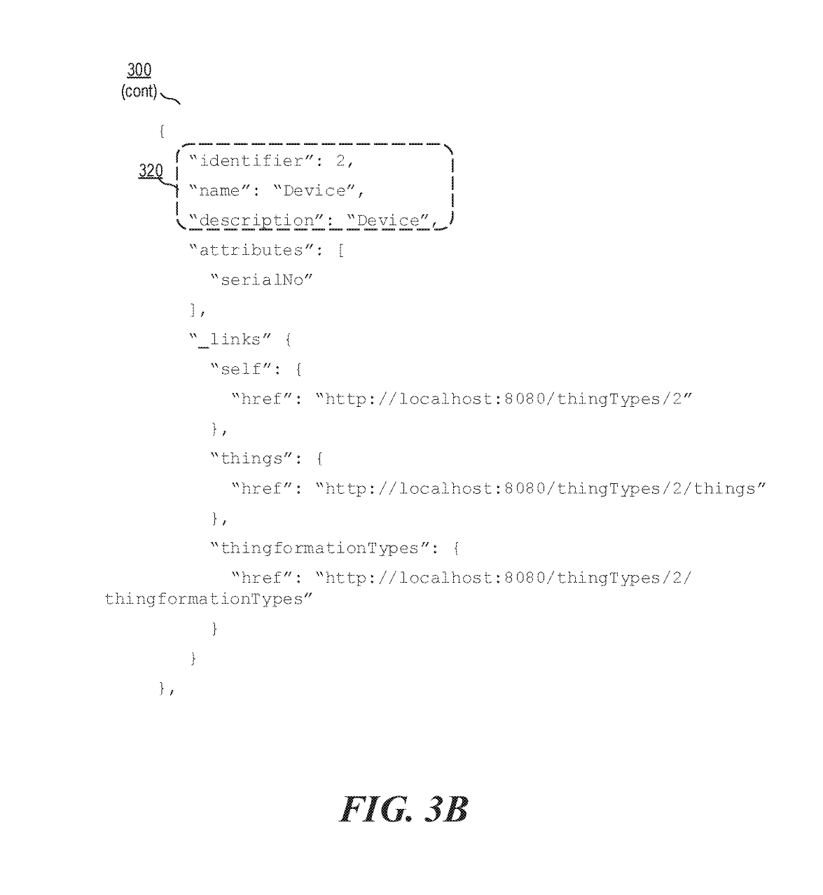

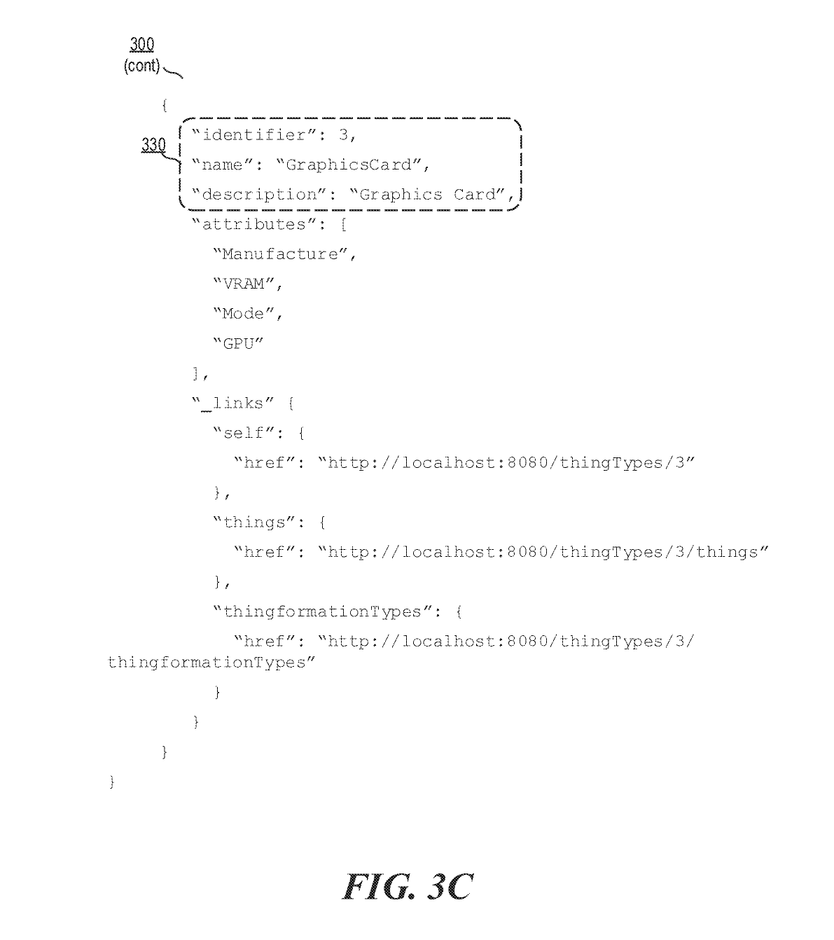

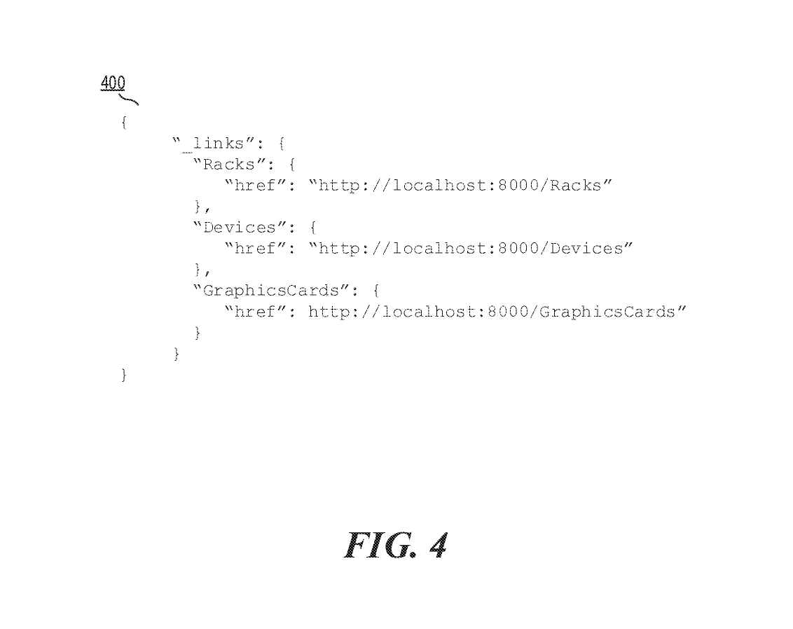

FIG. 2 is a block diagram of an example response generation using the domain-specific REST controller. FIGS. 3A-3C show example attributes from generic responses extracted by the domain-specific REST controller. FIG. 4 shows an example response generated by the domain-specific REST controller.

Specifically, in FIG. 2, a client 200 makes a Hypertext Transfer Protocol (HTTP) request to the domain-specific REST controller. In particular, the request corresponds to a root Uniform Resource Locator (URL) in a domain-specific REST API. The domain-specific REST controller receives the request from client 220 and begins processing the request. First, the domain-specific REST controller requests for all ThingTypes in an IoT domain 230 from IoT API 210. IoT API 210 will then send back a response, which is shown as response 300 in FIGS. 3A-3C. In this example, response 300 includes three different ThingTypes, such as, a Rack (as shown in attributes 310), a Device (as shown in attributes 320), and a GraphicsCard (as shown in attributes 330).

Next, the domain-specific REST controller extracts names from the returned ThingTypes 240, and pluralizes the extracted names 250. For example, from attributes 310-330, the domain-specific REST controller will extract “Rack,” “Device,” and “GraphicsCard” as names of Things in the IoT domain. Here, because the names are extracted from ThingTypes, the names are in a singular form. Then, the domain-specific REST controller pluralizes these names, because resource names need to be pluralized according to the Hypertext Application Language (HAL) standard. Thus, the Thing names will become “Racks,” “Devices,” and “GraphicsCards.” Thereafter, the domain-specific REST controller generates a HAL link for each pluralized name 260. The pluralized names are used in the rel portion of response 400. The href portion is the generated HAL link, which is the pluralized name appended to the root address of the domain-specific REST controller application. In this example, the HAL link generated for Rack is http://localhost:8000/Racks; the HAL link generated for Device is http://localhost:8000/Devices; the HAL link generated for GraphicsCard is http://localhost:8000/GraphicsCards.

The domain-specific REST controller then joins together the generated links in a response map entry with the key _links as per HAL standard and embeds the response map entry in an HTTP response 400 as shown in FIG. 4 to client 200. Note that, in response 400, instead of generic Thing names, the rel and href portions include domain-specific pluralized object names and links.

Generally, a REST application has a limited set of entry points. The set of entry points includes links where a client uses to start the REST application. The client then reaches other resources in the REST application by following a series of links in the response map returned from an entry point. In some implementations, the entry points may represent top level resources (e.g., http://localhost:8000/Racks may be the root URL for the Rack type resources; http://localhost:8000/Devices may be the root URL for the Device type resources; http://localhost:8000/GraphicsCards may be the root URL for the GraphicsCard type resources). In some implementations, the entry points may represent ThingformationTypes (e.g., Statuses, Events, Messages, etc.) instead of ThingTypes (e.g., Racks, Devices, GraphicsCards, etc.).

Individual or Collection Resource Representations

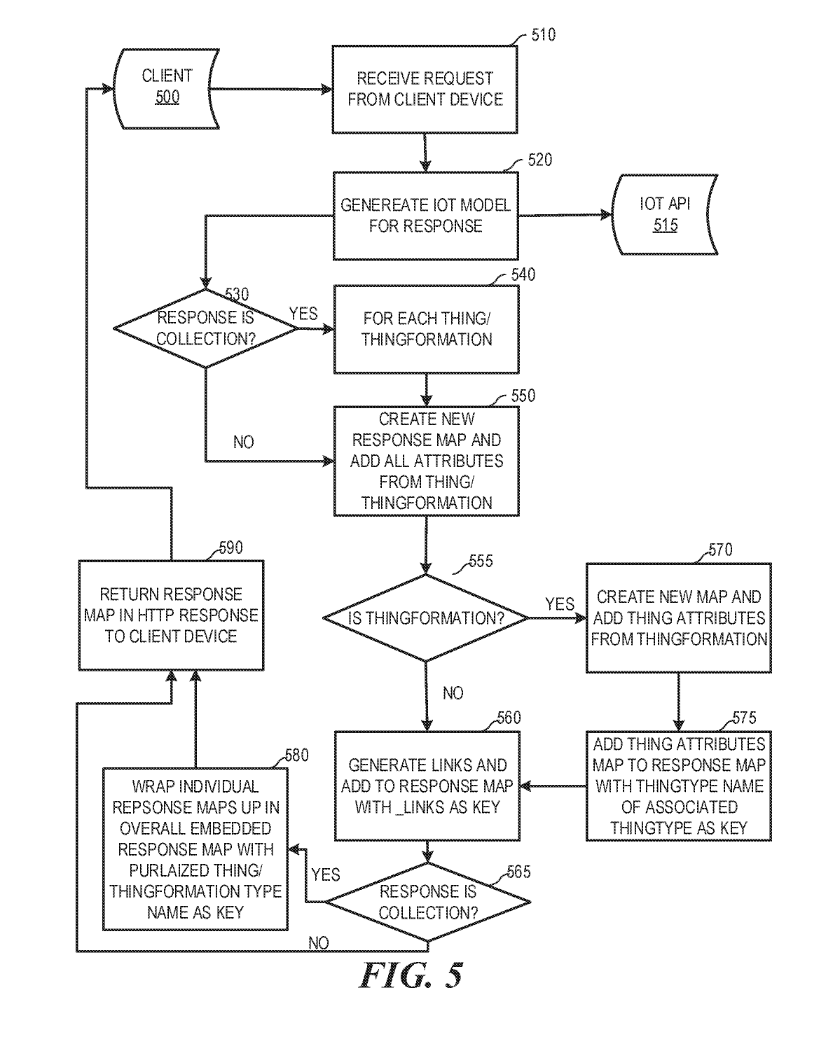

With reference to FIG. 5, the response generation of individual or collection resource representations begins when a client 500 makes an HTTP request to the domain-specific REST controller. The domain-specific REST controller receives the request from the client device at 510 and proceeds to generate an IoT model at 520 for a response to client 500. Specifically, the domain-specific REST controller creates an appropriate response of Things or Thingformations by interacting with IoT API 515. Then, the domain-specific REST controller determines whether the response is a collection response at 530. If the response is a collection response, then for each Thing or Thingformation 540, the domain-specific REST controller will create a response map and add all the attributes from the Attribute sub-collection of each Thing or Thingformation directly to the response map at 550. On the other hand, if the response is not a collection response (e.g., the response is an individual response), the domain-specific REST controller will create a single response map and add the attributes of a Thing or Thingformation to the response map at 550.

Next, the domain-specific REST controller determines whether the response map being produced is for a Thingformation at 555. If the response map is produced for a Thingformation, the domain-specific REST controller will create a new Thing map and add the Thing Attributes from the thingAttribute sub-collection of the Thingformation to the Thing map 570. Then, the domain-specific REST controller will add the thingAttribute map to the response map with a Key, which is the name of the ThingType of the Thing that is associated with the Thingformation 575. The domain-specific REST controller generates Hypermedia as the Engine of Application State (HATEOAS) links and adds them to the response map using the Key links as per HATEOAS standard 560. If the response map is not produced for a Thingformation (e.g., produced for a Thing), then the domain-specific REST controller will generate Hypermedia as the Engine of Application State (HATEOAS) links and add them to the response map using the Key _links as per HATEOAS standard 560.

Here, the domain-specific REST controller needs to determine whether the response is a collection response at 565. The decision made at 530 can be reused without additional computation. If the response is a collection response, the domain-specific REST controller will wrap the individual response maps together in an overall response map with the key _embedded and a sub-key, which is the pluralized name of the ThingType or ThingformationType (e.g., “Devices”) of the Things or Thingformations being returned as per HATEOAS standard at 580. The response map is then returned to client 500 in an HTTP response at 590. On the other hand, if the response is not a collection response (e.g., an individual response), then the domain-specific REST controller will directly return the response map in an HTTP response to client 500 at 590. Therefore, FIG. 5 covers response generation for an individual Thing or Thingformation, as well as for a collection of Things or Thingformations.

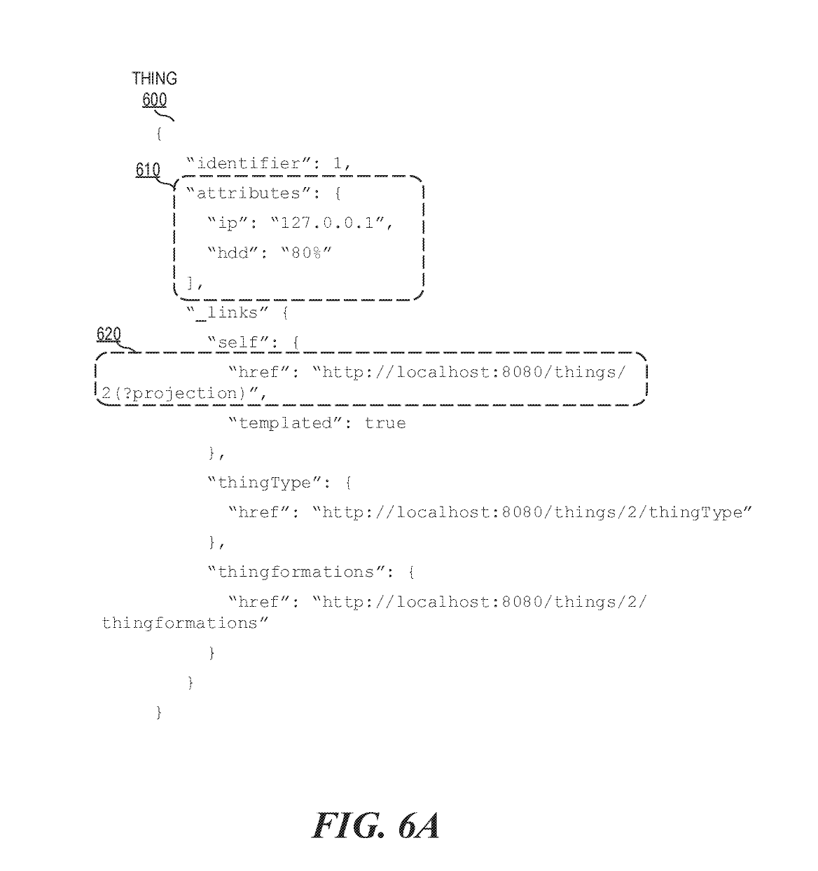

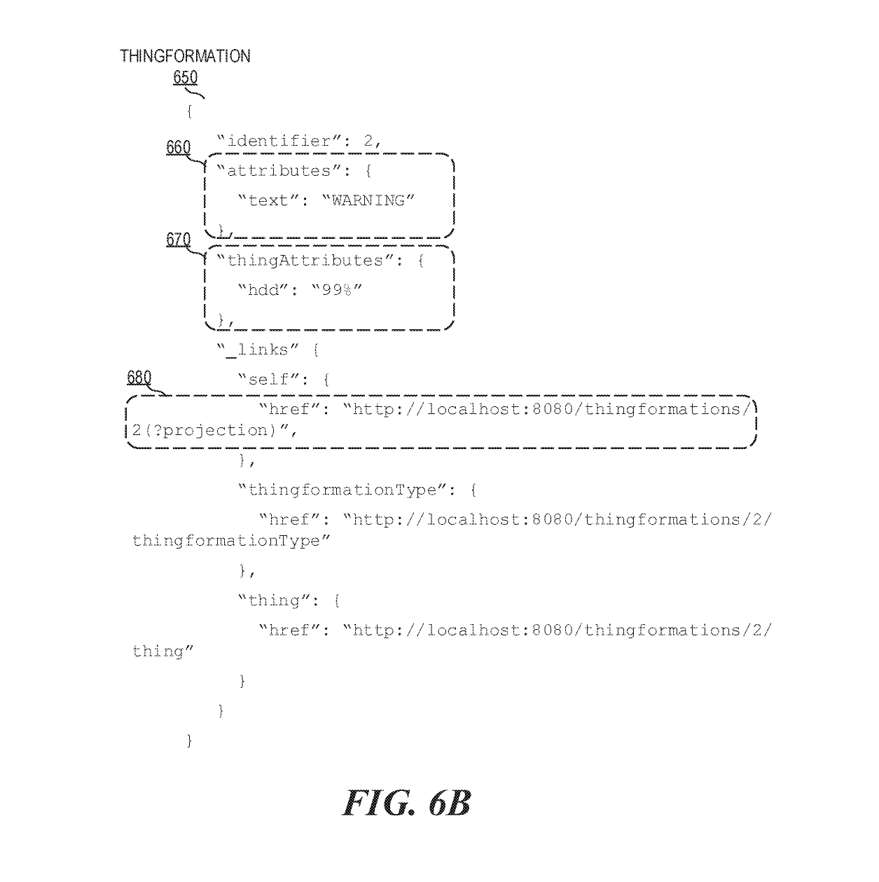

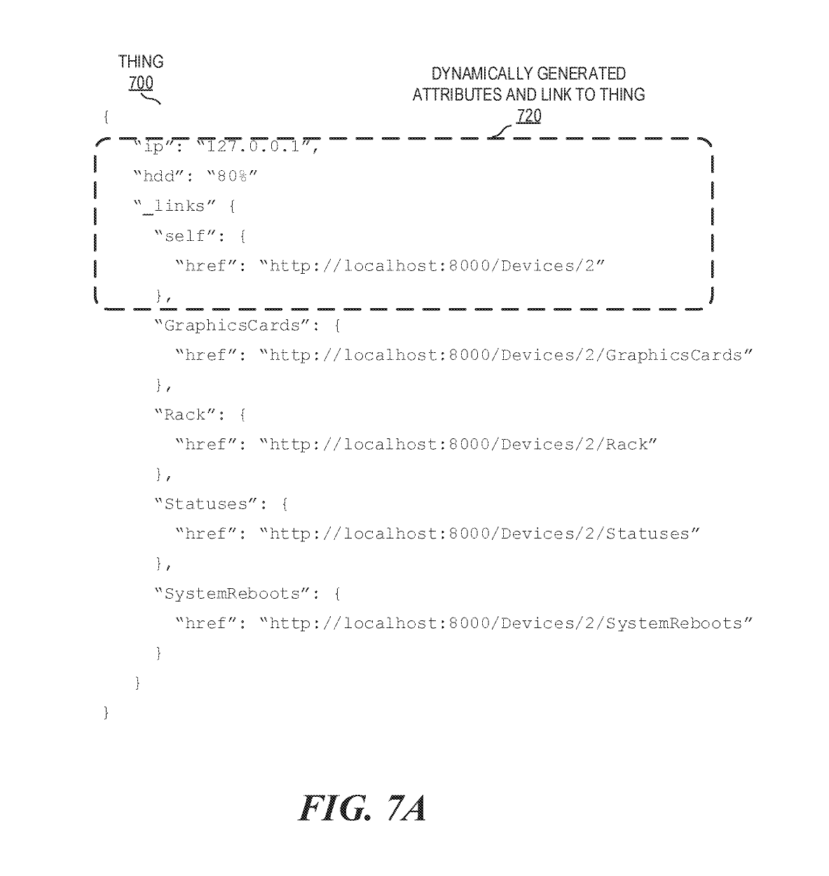

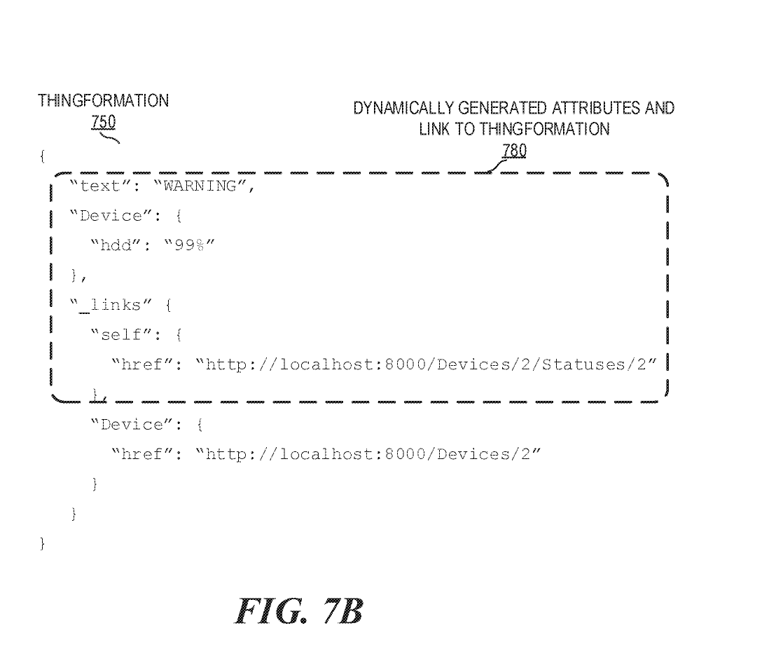

For example, FIG. 6A shows example attributes from generic responses corresponding to a Thing as extracted by the domain-specific REST controller. FIG. 7A shows an example response including dynamically generated attributes and link to a Thing as generated by the domain-specific REST controller. Here, a generic IoT representation of thing includes a plurality of attributes 610 (e.g., ip, hdd (hard disk drive), etc.) and a link 620 to the Thing object (e.g., http://localhost:8080/things/2(?projection)”). The attributes of Thing (e.g., ip, hdd, etc.) and their corresponding values are extracted from the Attribute sub-section of the generic response and added directly to the root level of the domain-specific response map (e.g., Thing 700 in FIG. 7A).

As another example, FIG. 6B shows example attributes from generic responses corresponding to a Thingformation as extracted by the domain-specific REST controller. FIG. 7B shows an example response including dynamically generated attributes and link to a Thingformation as generated by the domain-specific REST controller. Here, a generic IoT representation of Thingformation includes a plurality of attributes for the Thingformation (e.g., text 660) and a link 670 to the Thingformation object (e.g., http://localhost:8080/thingformations/2(?projection)”). The attributes of Thingformation (e.g., text 660) and their corresponding values are extracted from the Attribute sub-section of the generic response and added directly to the root level of the domain-specific response map (e.g., Thingformation 750 in FIG. 7B).

Moreover, as shown in FIG. 6B, Thingformation 650 is related to a Thing, which corresponds to a ThingType. The domain-specific REST controller can also determine the ThingType corresponding to the Thing that is related to the Thingformation. Then, the domain-specific REST controller extracts the name of the ThingType (e.g., “Device”) and use the name as a Key in the response map. The attributes of the Thing that is related to Thingformation (e.g., hdd 670) and their corresponding values are extracted from the thingAttributes sub-section of the generic response and, as a part of dynamically generated attributes and link to Thingformation 780, added to the domain-specific response map 750 under the Key (e.g., “Device”).

Note that the generated domain-specific response map can be directly deserialized into an object in an object oriented programming language. Also, the attributes used in this example are for illustration purposes only. They can be any piece of information that determines the properties or characteristics of an object in the IoT domain. The attributes are dynamically extracted from the generic response and added into the domain-specific response map. This process is performed automatically and does not depend on knowledge of particular attributes related to an IoT object (e.g., a Thing, a Thingformation, etc.)

Resource Links of Related Thingformations

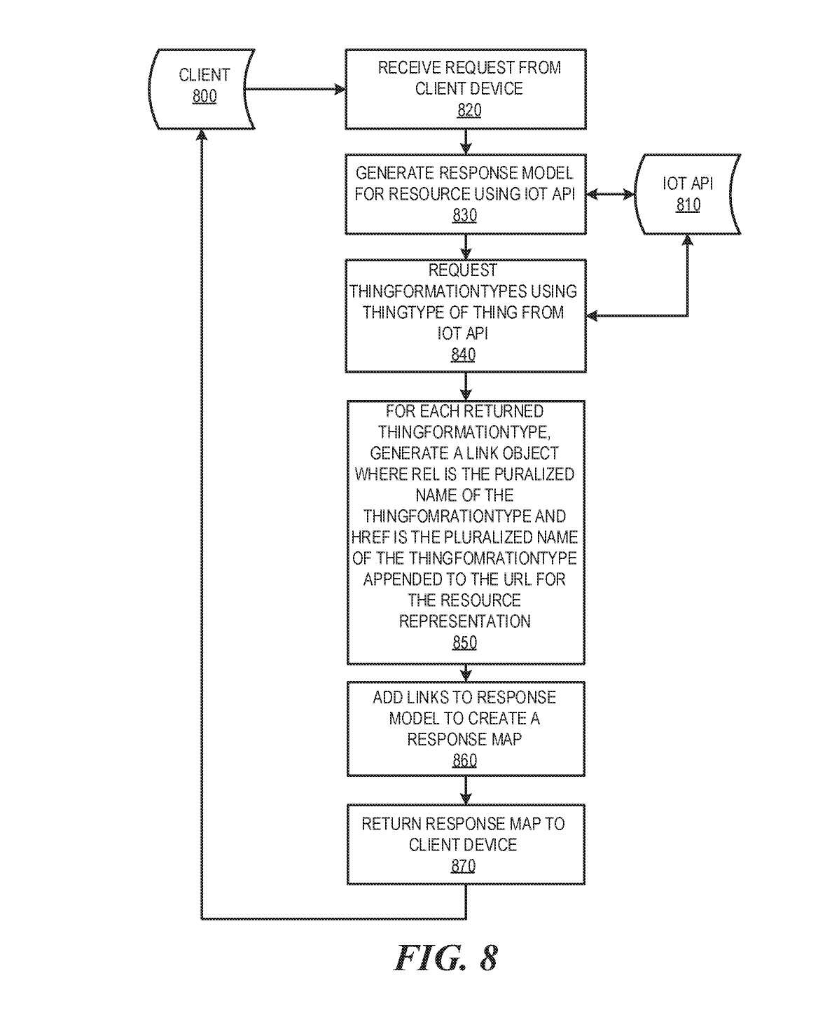

FIG. 8 is a block diagram of an example generation of response including resource links for related Thingformations using the domain-specific REST controller. FIG. 8 includes a client 800 and an IoT API 810. The response generation of resource links begins when client 800 makes an HTTP request to a domain-specific REST controller. The domain-specific REST controller receives request from client device at 820. At 830, the domain-specific REST controller generates an appropriate response model for the resource (e.g., a Thing) using IoT API 810. Next, at 840, the domain-specific REST controller requests a collection of ThingformationTypes from IoT API using the ThingType of the Thing being returned. At 850, for each returned ThingformationType, the domain-specific REST controller generates a link object (e.g., a new HATEOAS link), whereas the rel portion of the link is the pluralized name of the ThingformationType and the href portion of the link is the pluralized name of the ThingformationType appended to the URL of the individual Thing being returned. Thereafter, the domain-specific REST controller adds the links to the response model at 860, and returns in an HTTP response map to the client device at 870.

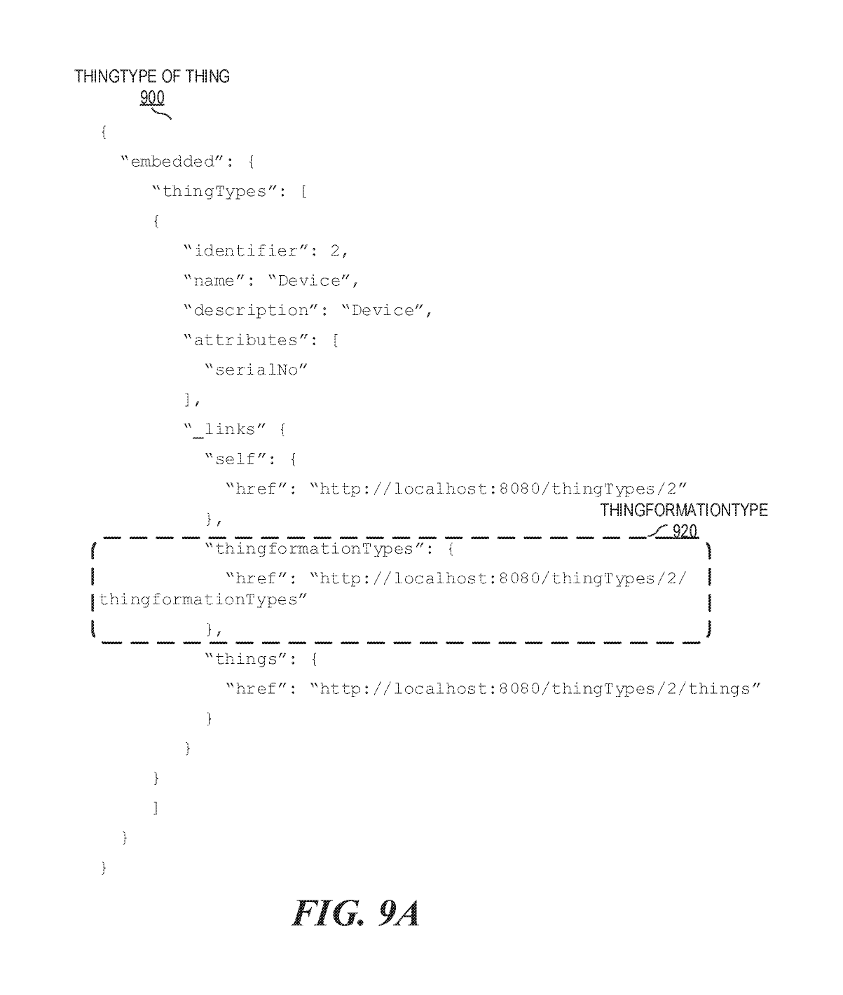

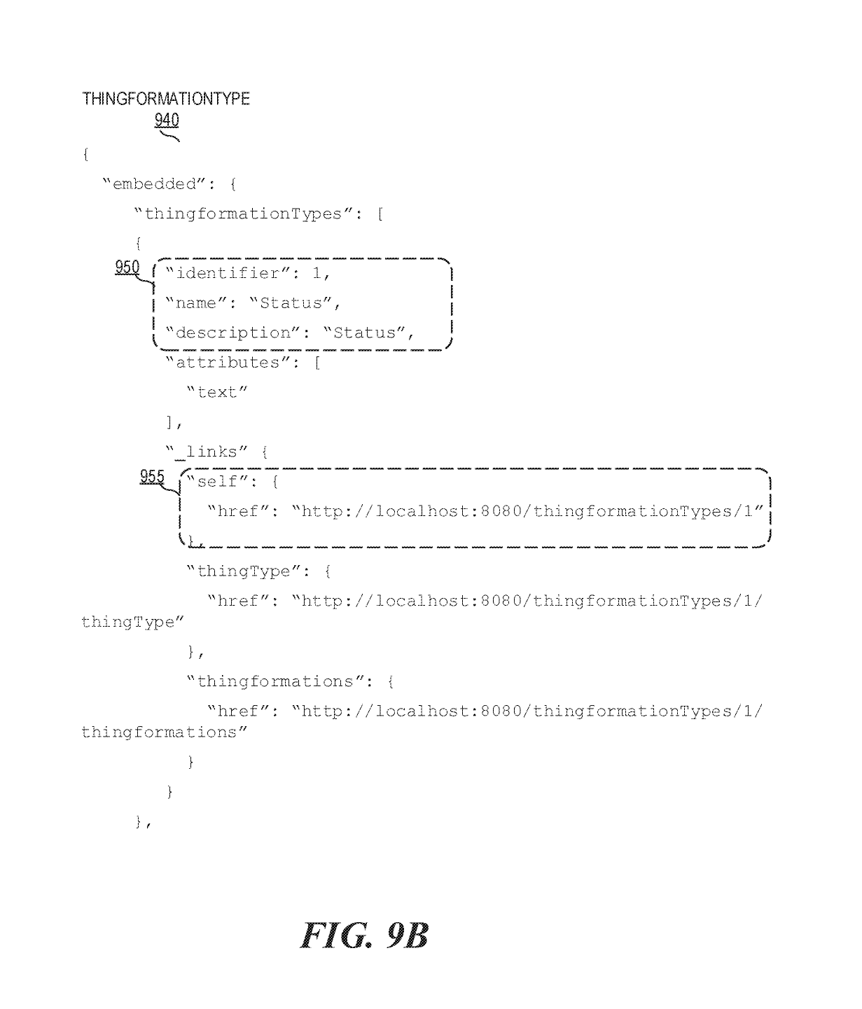

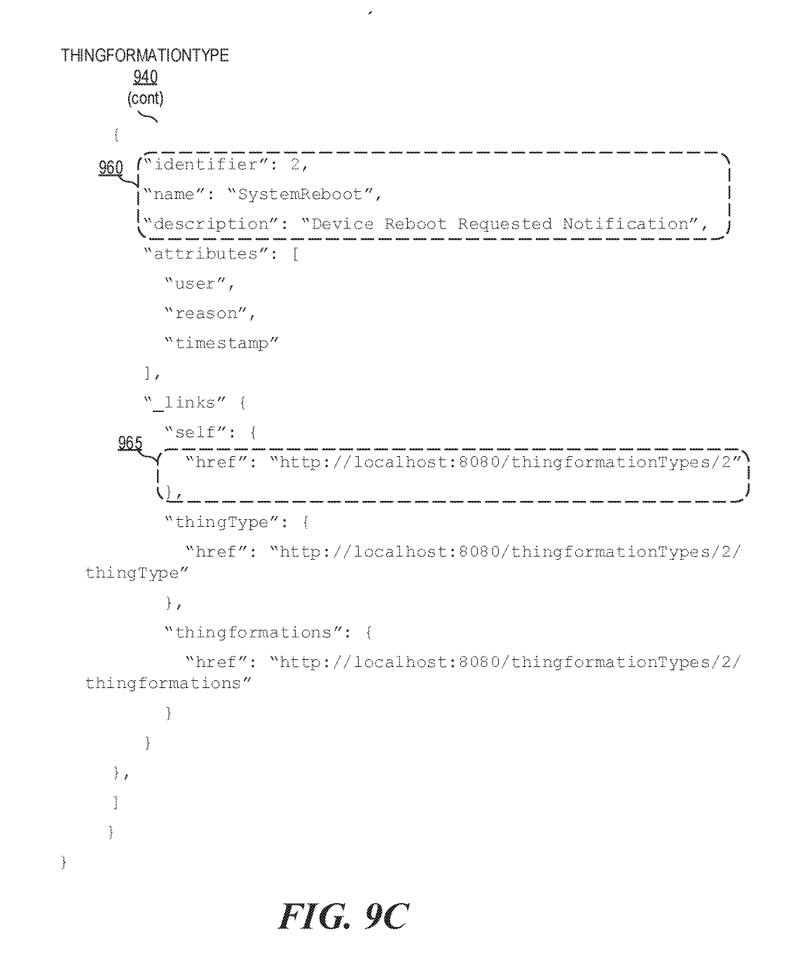

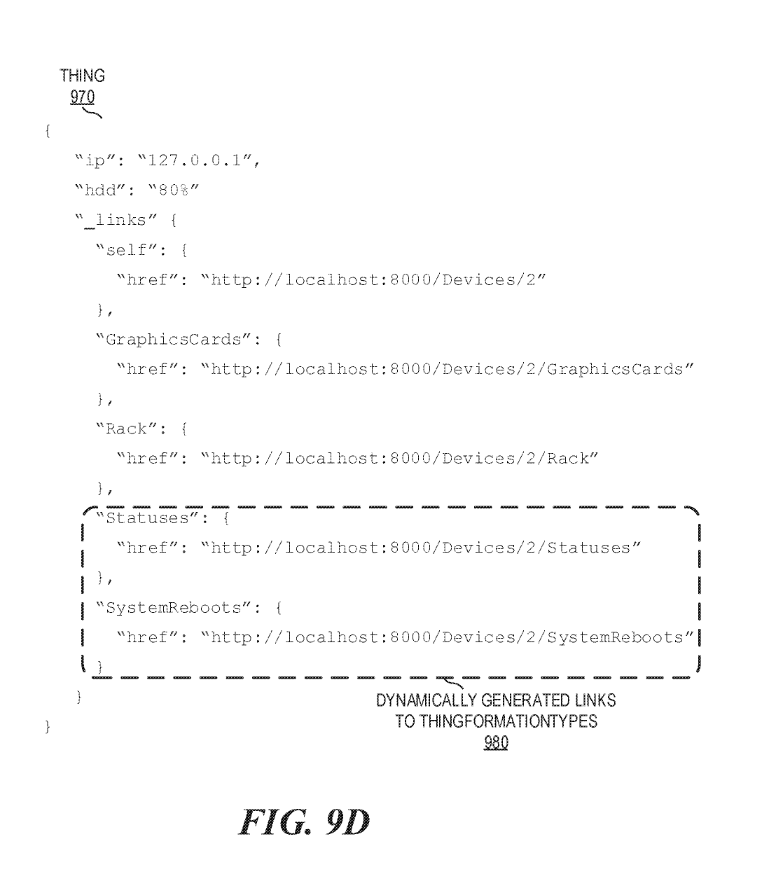

FIGS. 9A-9D show example responses illustrating dynamic generation of resource links for related thingformations using the domain-specific REST controller. Specifically, the domain-specific REST controller first de-pluralizes the ThingType (e.g., “Devices” to “Device”) extracted from the URL corresponding to a Thing. Then, in the IoT API, the domain-specific REST controller can perform a search by name in the ThingTypes, where the name equals to the de-pluralized ThingType (e.g., “Device”). The domain-specific REST controller will then receive a response corresponding to a ThingType of Thing 900 as shown in FIG. 9A.

Next, the domain-specific REST controller can extract a link to ThingformationType 920 from ThingType of Thing 900. Following the extracted link, the domain-specific REST controller will receive a response corresponding to ThingformationType 940 as shown in FIGS. 9B-9C. In this example, ThingformationType 940 includes two different ThingformationTypes: the first ThingformationType is called “Status,” and the second ThingformationType is called “SystemReboot.” For each ThingformationType 940, the domain-specific REST controller generates a link object, where the rel portion of the link is the pluralized name of the ThingformationType (e.g., “Statuses” or “systemReboots”) as extracted from portion 950 and 960 of the generic response map. Also, the href portion of the link is the pluralized name of the ThingformationType appended to the URL of the resource representation. In this example, the URL of the resource representation is an individual device, e.g., http://localhost:8000/Devices/2. Thus, the dynamically generated links to ThingformationTypes 980 in a resource representation (e.g., Thing 970) become http://localhost:8000/Devices/2/Statuses for Statuses and http://localhost:8000/Devices/2/SystemReboots for SystemReboots. The generated links allow an IoT user to retrieve all statuses or system reboot information related to a particular IoT device, i.e., same information provided by the generic IoT API when following the links 955 and 965 in the generic responses.

The Thingformations here are considered as related, because they are related to a particular Thing object. Note that there may be additional Thingformations besides the ones illustrated here (e.g., statuses, SystemReboots). However, the additional Thingformations are not related to the same Thing object (e.g., “Device”). Therefore, the additional Thingformations shall be appear in the links in a response map corresponding to a Device object.

Resource Links of Related Things

In an IoT API, individual Things can be related to each other. For example, a rack can include a plurality of devices; and, a device can include a plurality of graphics cards. In this manner, a rack, a device, and graphics cards can be related to each other. This section describes the generation of resource links for such related resources.

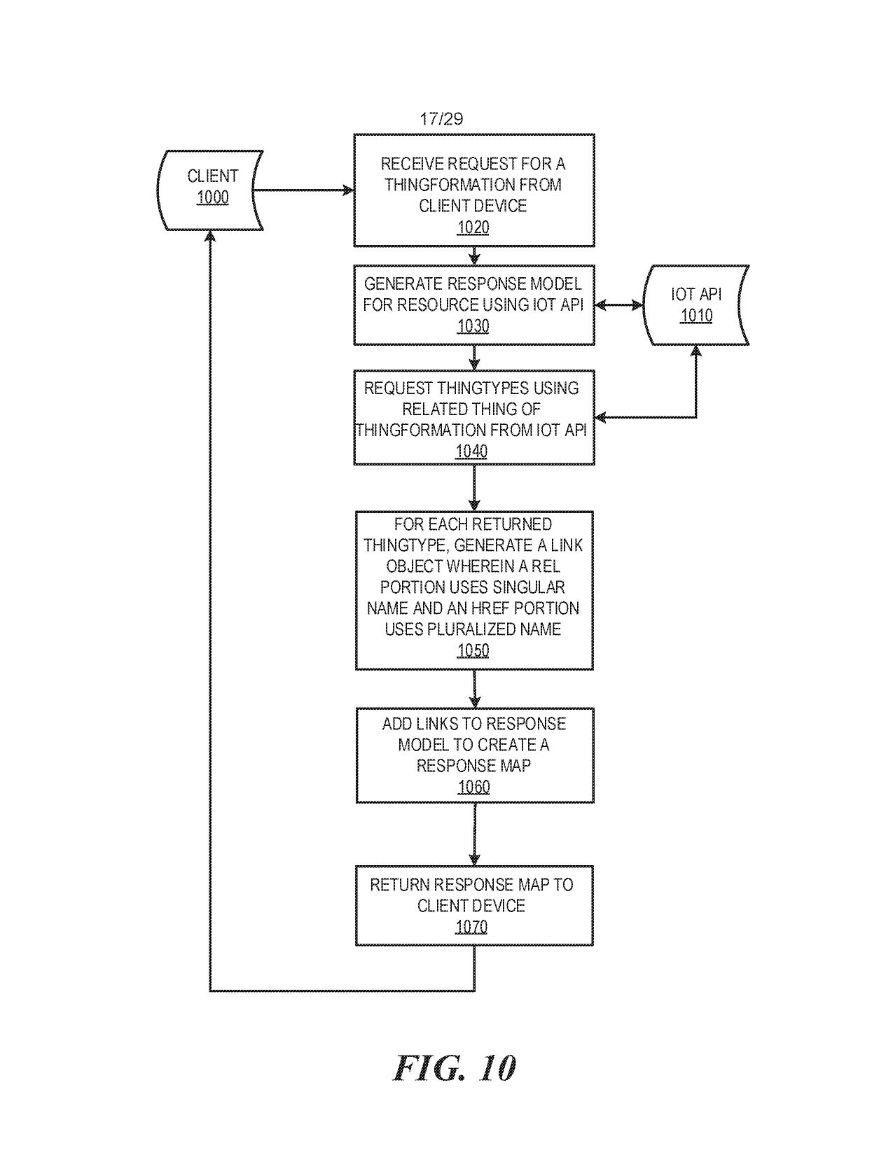

FIG. 10 is a block diagram of an example generation of response including resource links for related things using the domain-specific REST controller. FIG. 10 includes a client 1000 and an IoT API 1010. The response generation of resource links begins when client 1000 makes an HTTP request to a domain-specific REST controller. The domain-specific REST controller receives request for Thingformation from client device at 1020. At 1030, the domain-specific REST controller generates an appropriate response model for the resource (e.g., a Thingformation) using IoT API 1010. Next, at 1040, the domain-specific REST controller requests a collection of ThingTypes from the IoT API using the related Things of the Thingformation being returned. At 1050, for each returned ThingType, the domain-specific REST controller generates a link object (e.g., a new HATEOAS link), whereas the rel portion of the link is the singular form name of the ThingType and the href portion of the link is the pluralized name of the ThingType appended to the URL of the root, and then append the identifier of the individual Thing object. Thereafter, the domain-specific REST controller adds the links to the response model at 1060, and returns in an HTTP response map to the client device at 1070.

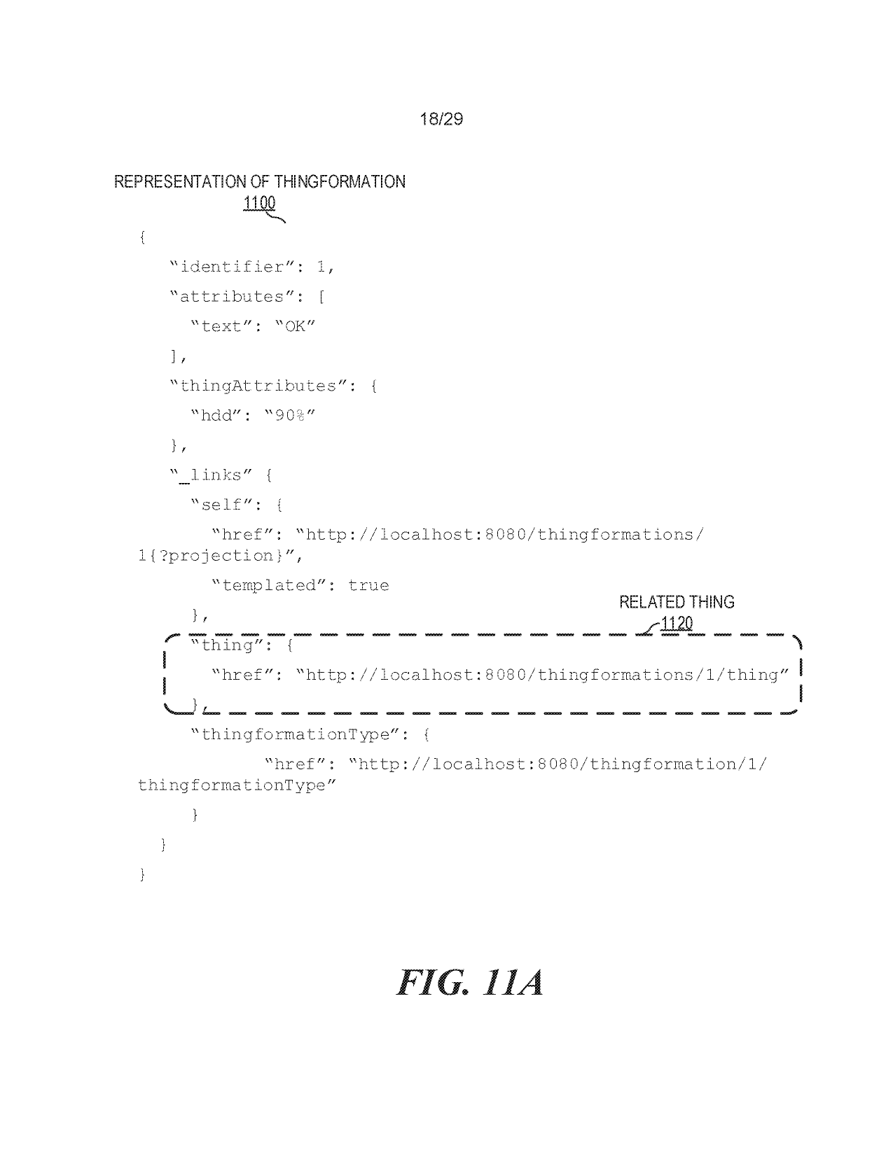

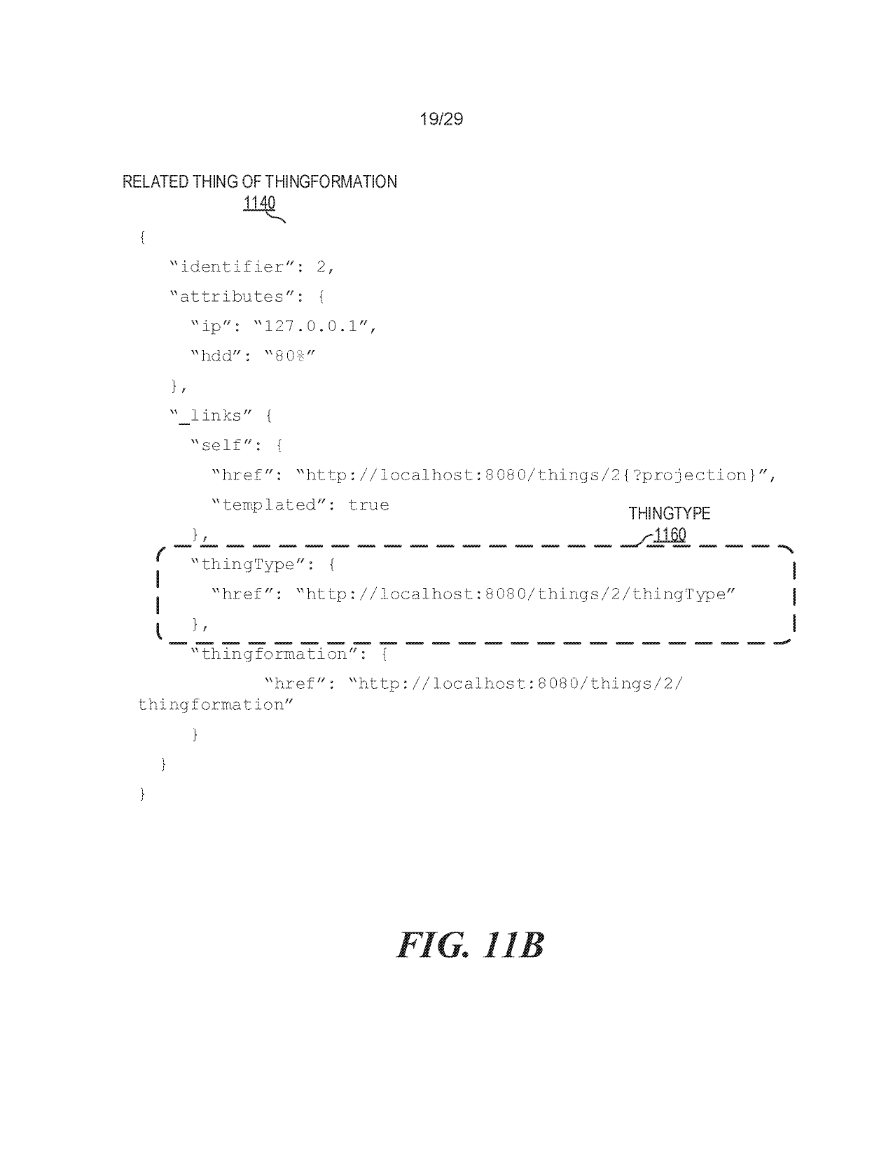

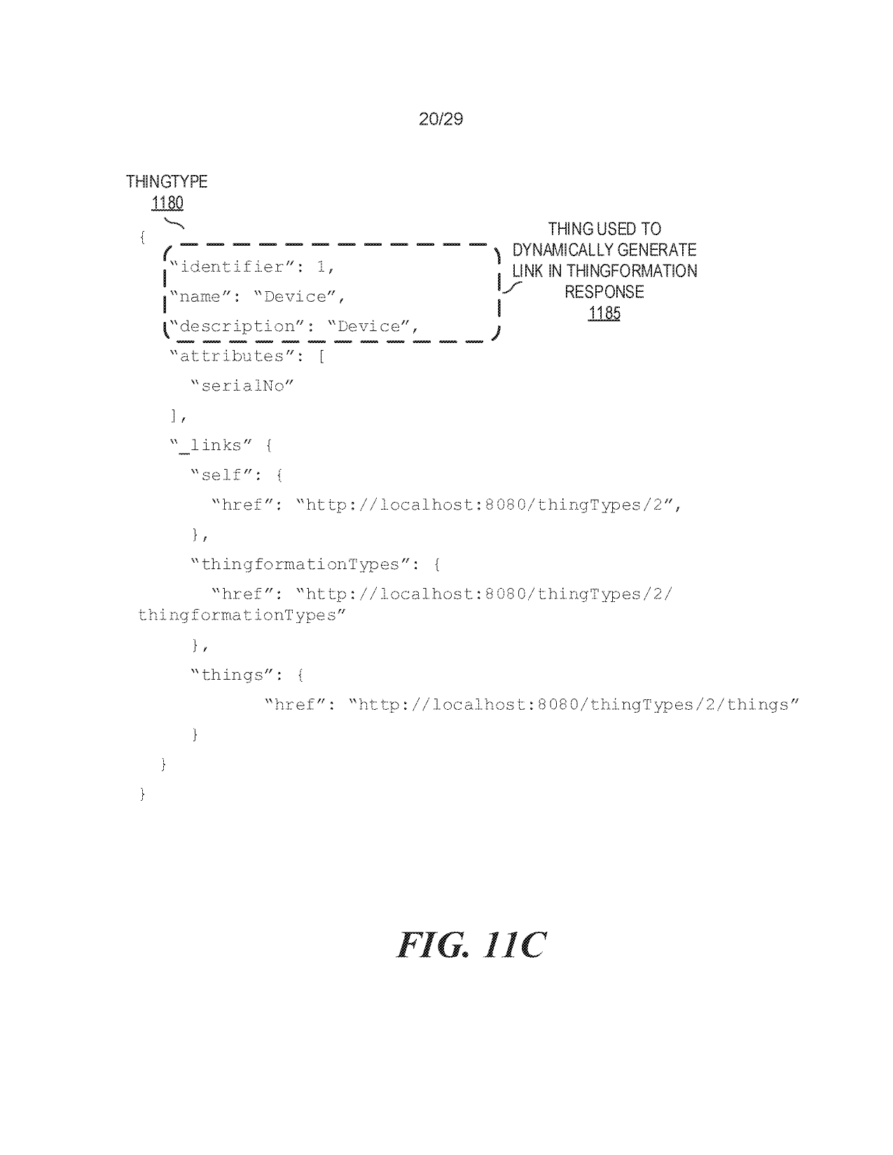

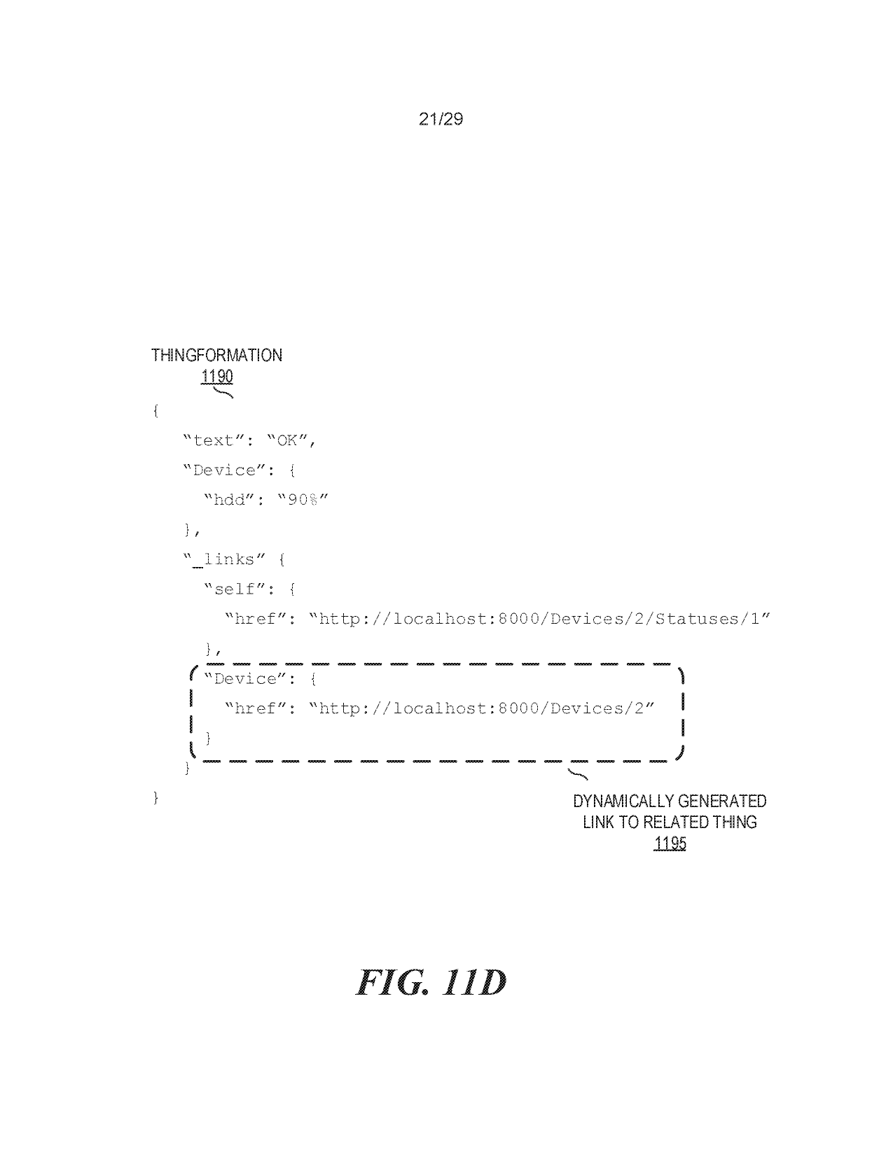

FIGS. 11A-11D show example responses illustrating dynamic generation of resource links for related things using the domain-specific REST controller. Specifically, as shown in FIG. 11A, from a representation of Thingformation 1100, the domain-specific REST controller first extracts a related Thing 1120. Then, the domain-specific REST controller will receive a generic response corresponding to a related Thing of Thingformation 1140 as shown in FIG. 11B. The domain-specific REST controller extracts a ThingType 1160 of the related Thing 1140. A generic response corresponding to the ThingType is shown in FIG. 11C. Here, ThingType 1180 includes an identifier, a name, and a description of the Thing. These information (e.g., “Device”) are used to dynamically generate a link in Thingformation response 1185. FIG. 11D shows a domain-specific response of Thingformation 1190, which includes a dynamically generated link to a related Thing (e.g., “Device”) http://localhost:8000/Devices/2.

It shall be noted that this link is generated based on the attributes in the ThingType of a related Thing to the Thingformation. Also, because only one Thing can be associated with a Thingformation, the rel portion of the link will have a singular form of the ThingType name (“Device”), but the href portion of the link will use the plural form of the ThingType name (“Devices”). Further, the href portion appends the pluralized name of the ThingType (“Devices”) to the root URL (http://localhost:8000), and then append the identifier of the individual Thing object (“2”). Also, every resource includes a self link that is identical to the current URL per HAL standard.

Resource Links of Nested Resources

A top-level resource generally refers to an individual or collection of resource that can be accessed by appending the resource information (e.g., type and identifier) to the root URL. For example, http://localhost:8000/devices/2 points to a top-level resource that is an individual device. The top-level resource is a global object and its existence does not depend on the existence of any other objects. On the other hand, a nested resource generally refers to a second level resource that is related to a top-level resource. For example, http://localhost:8000/devices/2/GraphicsCards points to a collection of graphics cards that are nested under a particular device. Although there might be many graphics cards existing in the IoT domain, the above link will only show graphics cards that are related to a particular device (e.g., belonging to the device with identifier number 2). In other words, nested resources can be considered as resources that are filtered based on their relationship with an individual or collection of top-level resources.

In fact, the dynamically generated links to ThingformationTypes 980 in FIG. 9D are another example of nested resources. As mentioned when describing FIG. 8, in order to generate the nested Thingformation links, the domain-specific REST controller retrieves the ThingType of the Thing, and then requests all ThingformationTypes using the ThingType. Thus, the link generation of nested resource corresponding to nested Thingformations is relatively simple.

The link generation of nested resources corresponding to Things is more complex than that corresponding to Thingformations, because the relationship between things are explicit. Thus, a relationship object needs to be created within the IoT domain to describe relationships between things in the IoT domain.

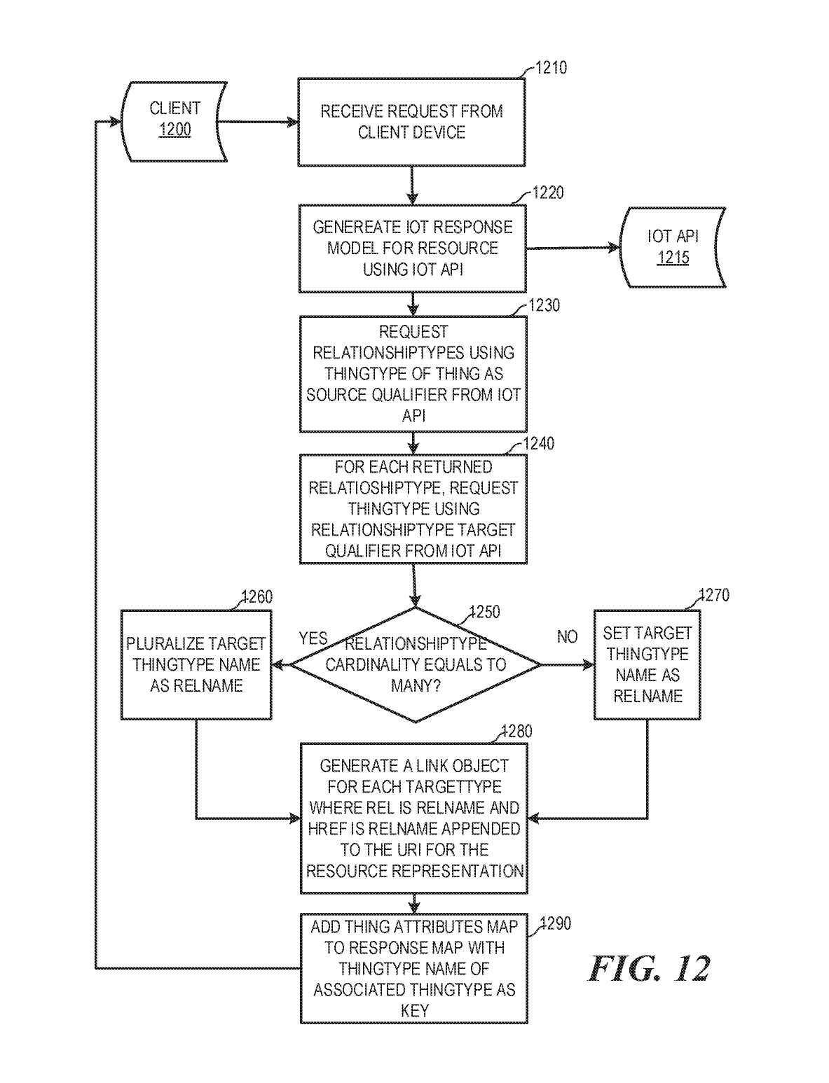

Referring now to FIG. 12, the response generation of nested resources corresponding to things begins when a client 1200 makes an HTTP request to the domain-specific REST controller. At 1210, the domain-specific REST controller receives the request from the client device 1200. Then, at 1220, the domain-specific REST controller generates an appropriate IoT response model for the resource (e.g., a Thing) using the IoT API 1215. Next, the domain-specific REST controller requests a collection of RelationshipTypes from the IoT API using the ThingType of the Thing being returned as a source qualifier at 1230. At 1240, for each returned RelationshipType, the domain-specific REST controller makes a request to the IoT API for the ThingType, which is the Target Qualifier of the RelationshipType. At 1250, the domain-specific REST controller determines whether the cardinality of each returned RelationshipType equals MANY. If the RelationshipType cardinality is MANY, then the domain-specific REST controller pluralizes target ThingType name as relName at 1260. On the other hand, if the RelationshipType cardinality is not MANY (e.g., the RelationshipType cardinality is ONE), then the domain-specific REST controller creates a variable relName and set target ThingType name as relName at 1270. At 1280, for each target type, the domain-specific REST controller will create a link object, where the rel portion of the link is the relName and the href portion of the link is the relName appended to the URL of the individual resource representation being created. At 1290, the domain-specific REST controller will add the Links to the response model. Specifically, the domain-specific REST controller will add ThingAttributes map to the response map with ThingType name of associated ThingType as a key, and return it in an HTTP response to client 1200.

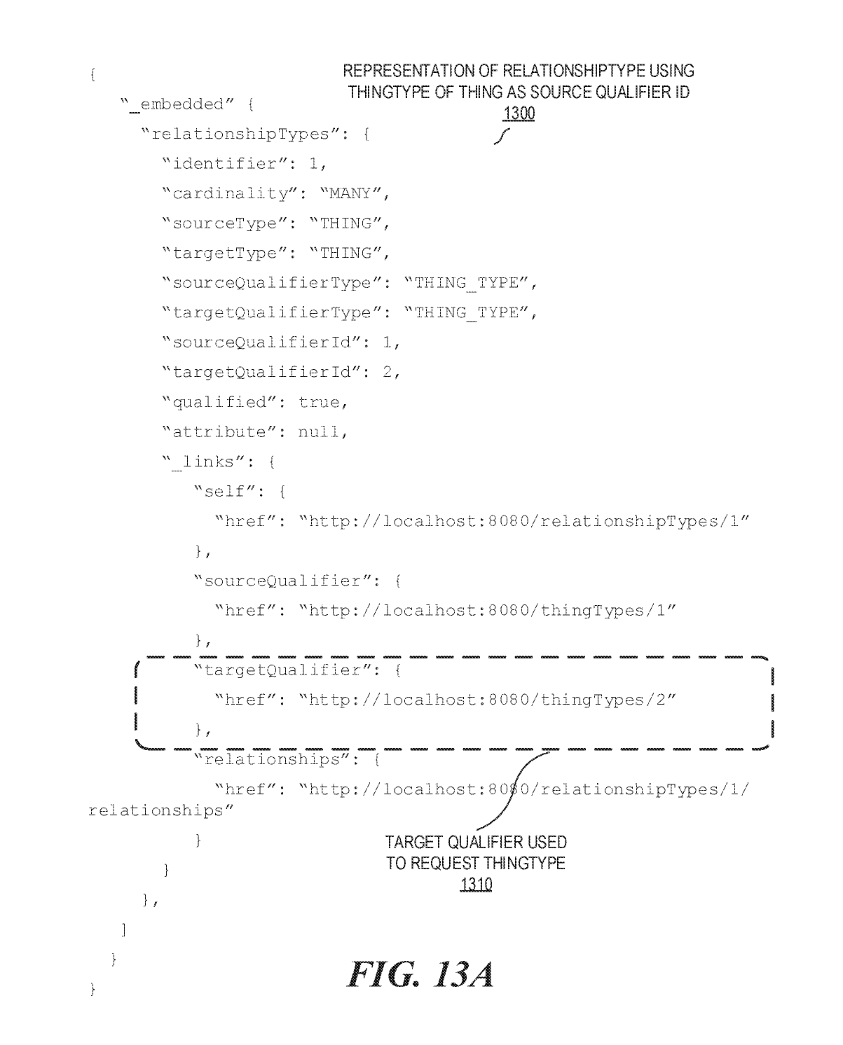

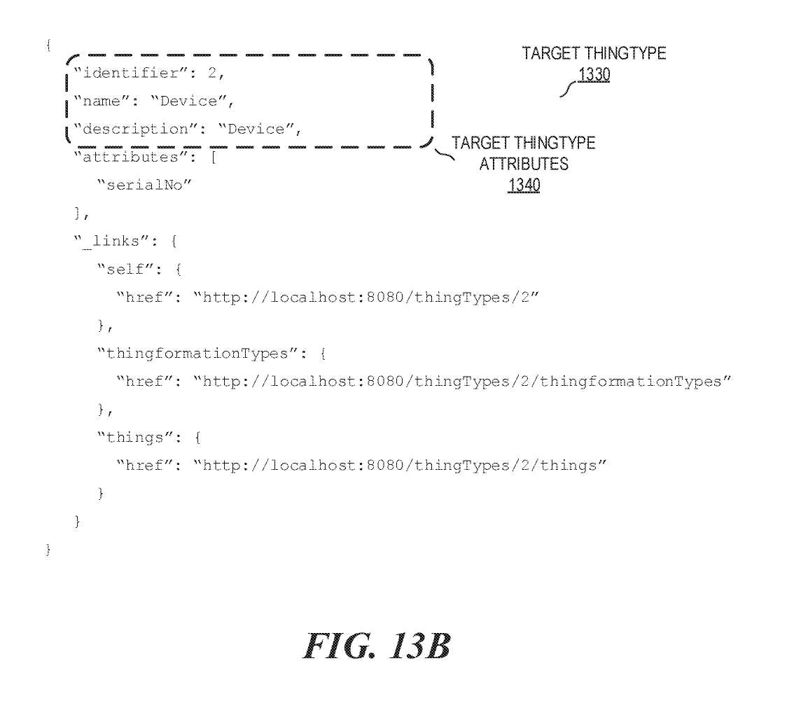

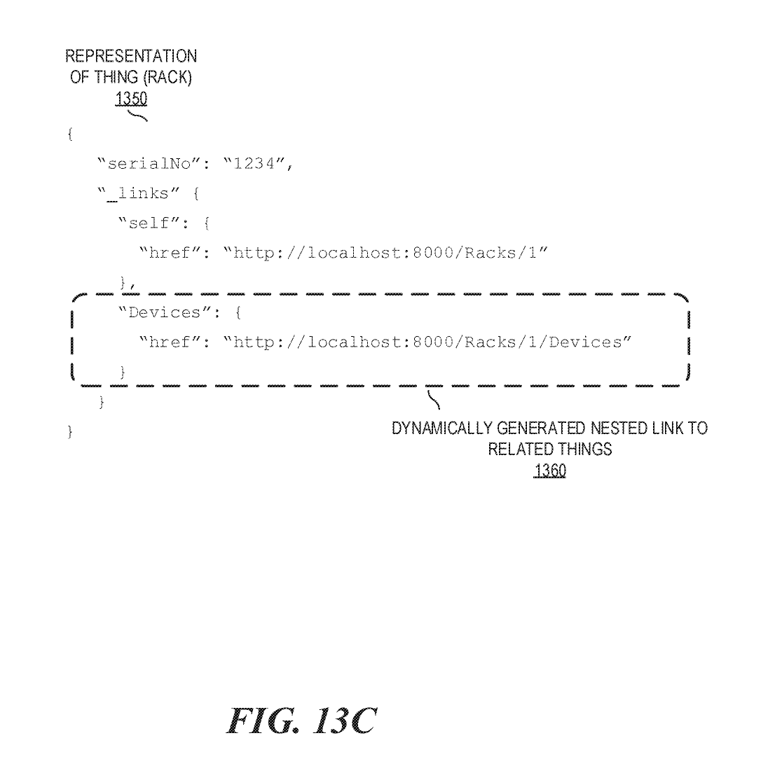

FIGS. 13A-13C show example responses illustrating dynamic generation of resource links for nested resources using the domain-specific REST controller. In this example, one rack can contain many devices. Assuming that this is the only relationship that a rack can have to other things in the IoT domain. Also, for illustration purposes only, assuming that the identifier corresponding to the ThingType for the Racks is 1 and the identifier corresponding to the ThingType for the Devices is 2. Moreover, to describe the relationship between Rack and Devices in this example, a RelationshipType is created, which is shown in FIG. 13A. Specifically, RelationshipType shown in FIG. 13A maps the ThingType with identifier 1 (e.g., Racks) to the ThingType with identifier 2 (e.g., Devices). In particular, representation of RelationshipType is obtained by using ThingType of Thing as source qualifier ID 1300 (e.g., identifier “1” corresponding to Racks as the source qualifier ID) and it includes the following lines:

“cardinality”: “MANY”,
“sourceType”: “THING”,
“targetType”: “THING”,
“sourceQualifierType”: “THING_TYPE”,
“targetQualifierType”: “THING_TYPE”,
“sourceQualifierId”: 1,
“targetQualifierId”: 2,

The above RelationshipType attributes define that the relationship type is from Racks to Devices. Moreover, the cardinality value is “MANY,” which indicates that the target of the RelationshipType will be MANY. Thus, the relationship can be a 1-to-MANY Relationship, or a MANY-to-MANY relationship, or even a 0-to-MANY relationship.

Then, the domain-specific REST controller will request the ThingType using the RelationshipType target qualifier 1310. Following target qualifier 1310, the domain-specific REST controller will receive a generic response corresponding to a Target ThingType 1330 as shown in FIG. 13B. The generic response corresponding Target ThingType 1330 includes the following lines:

“identifier”: 2,
“name:: “Device”,
“description”: “Device”,

Based on the above target ThingType attributes information 1340, the domain-specific REST controller can determine that the target ThingType is pointing to a Device in this example. If the RelationshipType is MANY, the domain-specific REST controller will pluralize the target ThingType name. Otherwise, the domain-specific REST controller will use the singular form of the target ThingType name.

Then, the domain-specific REST controller can dynamically generate nested links to related things 1360 as shown in FIG. 13C. Specifically, the domain-specific REST controller uses either singular or plural form of target ThingType name as the rel portion of the link depending on the RelationshipType. Also, the domain-specific REST controller appends either singular or plural form of the target ThingType name (e.g., “Devices”) to the URL corresponding to the link of the individual thing (e.g., a Rack with identifier 1). Thus, in this example, the domain-specific REST controller will generate a nested link 1360 whose href portion is in the form of http://localhost:8000/Racks/1/Devices.

Note that although a relationship between ThingType and ThingType is illustrated in this example, a RelationshipType could also be created to describe any relationships between any types of objects in an IoT domain, for example, a relationship between a user and a thing (e.g., users and things that each user owns), a relationship between a user and an entity (e.g., users and entities that each user belongs to), etc.

Processes to Generate a Response to a Client Device in an IoT Domain

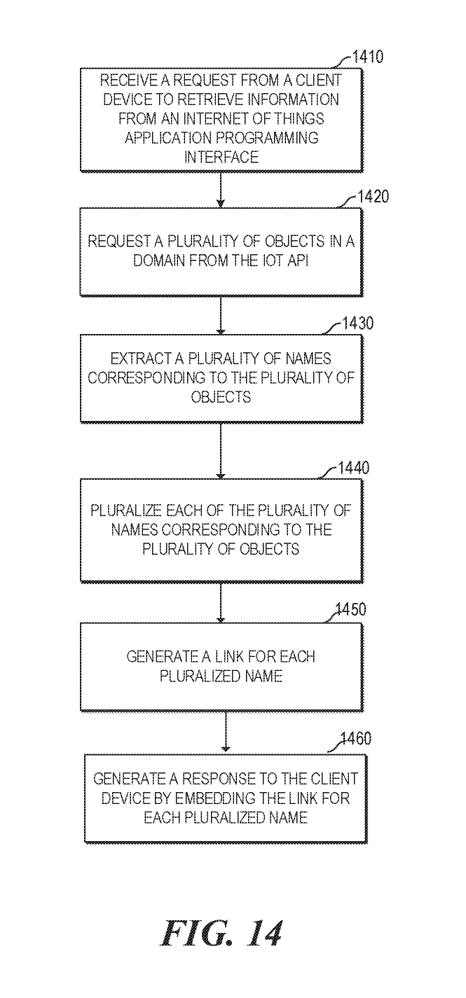

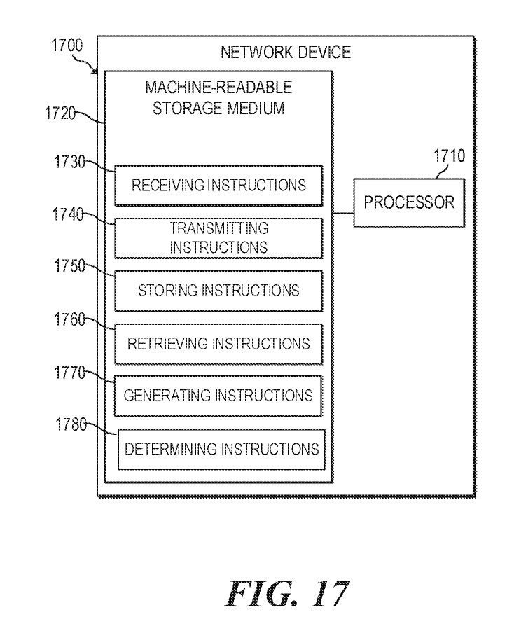

In discussing FIGS. 14-16, references may be made to the components in FIGS. 1-13 to provide contextual examples. In one implementation, the domain-specific REST controller 105 as in FIG. 1 executes operations 1410-1460 to generate a response to a client device in an IoT domain. In one implementation, the domain-specific REST controller 105 as in FIG. 1 executes operations 1510-1550 to generate a response to a client device in an IoT domain. In one implementation, the domain-specific REST controller 105 as in FIG. 1 executes operations 1610-1660 to generate a response to a client device in an IoT domain. Further, although FIGS. 14-16 are described as implemented by a controller, it may be executed on other suitable components. For example, FIGS. 14-16 may be implemented in the form of executable instructions on a machine-readable storage medium 1720 as in FIG. 17.

FIG. 14 is a flowchart of an example process to generate a response to a client device of an IoT domain using domain-specific REST controller. First, a computing device (e.g., the domain-specific REST controller) receives a request from a client device to retrieve information from an Internet of Things (IoT) Application Programming Interface (API) (operation 1410). Here, the IoT API is a generic IoT API.

Then, the computing device requests a plurality of objects in a domain from the IoT API (operation 1420). Moreover, the computing device extracts a plurality of names corresponding to the plurality of objects (operation 1430). Then, the computing device pluralizes each of the plurality of names corresponding to the plurality of objects (operation 1440).

Further, the computing device generates a link for each pluralized name (operation 1450). The link for each pluralized name comprises a link using Hypertext Application Language (HAL) format. Specifically, a rel portion of the link includes the pluralized name; and a href portion of the link includes a backslash concatenated with the pluralized name. In some implementations, the computing device may join the link for each pluralized name in a _links map in the response to the client device.

Subsequently, the computing device generates a response to the client device by embedding the link for each pluralized name (operation 1460). The response to the client device may include entry points to a domain-specific API.

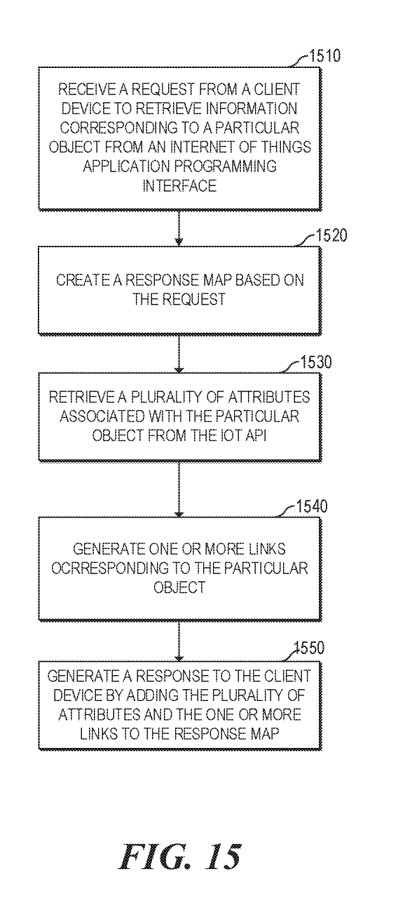

FIG. 15 is a flowchart of an example process to generate a response to a client device of an IoT domain using domain-specific REST controller. First, a computing device (e.g., the domain-specific REST controller) receives a request from a client device to retrieve information corresponding to a particular object from an Internet of Things (IoT) Application Programming Interface (API) (operation 1510). Then, the computing device creates a response map based on the request (operation 1520). Moreover, the computing device retrieves a plurality of attributes associated with the particular object from the IoT API (operation 1530). Then, the computing device generates at least one link corresponding to the particular object; (operation 1540). Subsequently, the computing device generates a response to the client device by adding the plurality of attributes and the at least one link to the response map (operation 1550).

In some implementations, the computing device further determines whether the response includes a collection of objects. If the response includes the collection of objects, for each object in the collection, the computing device will create a response map corresponding to a respective object. Then, the computing device will retrieve a plurality of attributes from the IoT API associated with the respective object. Further, the computing device generates at least one link corresponding to the respective object. Then, the computing device adds the plurality of attributes and the at least one link corresponding to the respective object to the response map. In some implementations, if the response includes the collection of objects, the computing device further pluralizes a type name corresponding to the particular object, and embeds each response map corresponding to the respective object to the response to the client device using the pluralized type name as a key.

In some implementations, the computing device determines whether the particular object is a thing or a message. If the particular object is a message, the computing device will retrieve thing attributes associated with the message from the IoT API, and add the thing attributes to the response map. Specifically, to add the thing attributes to the response map, the computing device determines an object type associated with the message, and adds the thing attributes to the response map using a type name of the object type associated with the message as a key.

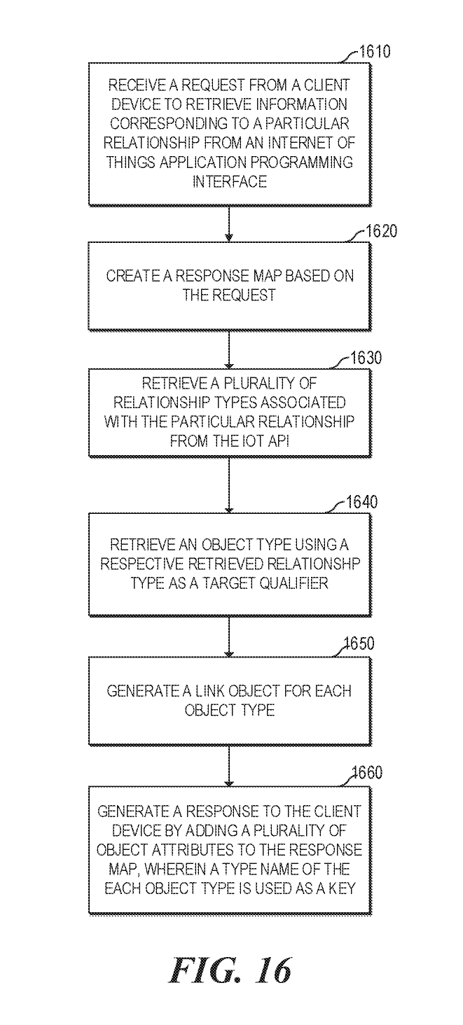

FIG. 16 is a flowchart of an example process to generate a response to a client device of an IoT domain using domain-specific REST controller. First, a computing device (e.g., the domain-specific REST controller) receives a request from a client device to retrieve information corresponding to a particular relationship from an Internet of Things (IoT) Application Programming Interface (API) (operation 1610). The computing device then creates a response map based on the request (operation 1620). Next, the computing device retrieves a plurality of relationship types associated with the particular relationship from the IoT API (operation 1630). Also, the computing device retrieves an object type using a respective retrieved relationship type as a target qualifier from the IoT API (operation 1640). Further, the computing device generates a link object for each object type (operation 1650). Subsequently, the computing device generates a response to the client device by adding a plurality of object attributes to the response map, whereas a type name of the each object type is used as a key.

In some implementations, the computing device retrieves the plurality of relationship types associated with the particular relationship from the IoT API by using an object type of an object associated with a respective relationship type as a source qualifier from IoT API.

In some implementations, the computing device further determines whether a cardinality of a respective relationship type is many. If so, the computing device pluralizes the type name of the object type, and uses the pluralized type name as a rel portion in the response to the client device. If, on the other hand, the cardinality of the respective relationship type is one, the computing device will use a singular type name as the rel portion in the response to the client device.

In some implementations, the computing device retrieves a plurality of message types using an object type of a particular object from the IoT API. For each of the plurality of message types, the computing device generates a link object. Specifically, a rel portion of the generated link includes a pluralized name of a respective message type, and a href portion of the generated link includes a pluralized name of the respective message type appended to the link. Then, the computing device adds the link object to the response to the client device.

In some implementations, the computing device retrieves a plurality of object types using a related object of a particular message from the IoT API. For each of the plurality of object types, generating a link object. Specifically, a rel portion of the generated link includes a singular name of a respective object type, and a href portion of the generated link includes a pluralized name of the respective object type appended to the link. Then, the computing devices adds the link object to the response to the client device.

Network Device to Generate a Response to a Client Device in an IoT Domain

FIG. 17 is a block diagram of an example network device with at least one processor 1710 to execute instructions 1730-1780 within a machine-readable storage medium 1720 to generate a response to a client device in an IoT domain. Although the network device 1700 includes at least one processor 1710 and machine-readable storage medium 1720, it may also include other components that would be suitable to one skilled in the art. For example, network device 1700 may include an additional processing component and/or storage. In another implementation, the networking component (e.g., domain-specific REST controller 105 in FIG. 1) executes instructions 1730-1780. Network device 1700 is an electronic device with the at least one processor 1710 capable of executing instructions 1730-1780, and as such implementations of network device 1700 include a mobile device, server, data center, networking device, client device, computer, or other type of electronic device capable of executing instructions 1730-1780. The instructions 1730-1780 may be implemented as methods, functions, operations, and other processes implemented as machine-readable instructions stored on the storage medium 1720, which may be non-transitory, such as hardware storage devices (e.g., random access memory (RAM), read only memory (ROM), erasable programmable ROM, electrically erasable ROM, hard drives, and flash memory).

The at least one processor 1710 may fetch, decode, and execute instructions 1730-1780 to generate a response to a client device in an IoT domain. Specifically, the at least one processor 1710 executes instructions 1730-1780 to: receive a request from a client device to retrieve information from an Internet of Things (IoT) Application Programming Interface (API); request a plurality of objects in a domain from the IoT API; extract a plurality of names corresponding to the plurality of objects; pluralize each of the plurality of names corresponding to the plurality of objects; creatie a response map based on the request; determine whether the response includes a collection of objects; determine whether the particular object is a thing or a message; determine whether an object type is associated with the message; determine whether a cardinality of a respective relationship type is many; retrieve a plurality of attributes associated with a particular object from the IoT API; retrieve a plurality of relationship types associated with a particular relationship from the IoT API; retrieve an object type using a respective retrieved relationship type as a target qualifier from the IoT API; retrieve a plurality of relationship types using an object type of an object associated with a respective relationship type as a source qualifier from IoT API; retrieve a plurality of message types using an object type of a particular object from the IoT API; retrieve a plurality of object types using a related object of a particular message from the IoT API; generate at least one link corresponding to a particular object; join the links in a _links map; add the plurality of attributes and the at least one link corresponding to a respective object to the response map; add the thing attributes to the response map using a type name of the object type associated with the message as a key; use the pluralized type name as a rel portion in the response to the client device if the cardinality of a respective relationship type is many; use a singular type name as the rel portion in the response to the client device if the cardinality of a respective relationship type is one; embed each response map corresponding to the respective object to the response to the client device using the pluralized type name as a key; generate a response to the client device by adding the plurality of attributes and the at least one link to the response map or by embedding the link for each pluralized name; etc.

The machine-readable storage medium 1720 includes instructions 1730-1780 for the processor 1710 to fetch, decode, and execute. In another example, the machine-readable storage medium 1720 may be an electronic, magnetic, optical, memory, storage, flash-drive, or other physical device that contains or stores executable instructions. Thus, the machine-readable storage medium 1720 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 1720 may include an application and/or firmware which can be utilized independently and/or in conjunction with the at least one processor 1710 to fetch, decode, and/or execute instructions of the machine-readable storage medium 1720. The application and/or firmware may be stored on the machine-readable storage medium 1720 and/or stored on another location of the network device 1700.

We claim:

1. A method comprising:
receiving, by a computing device, a request from a client device to retrieve information from an Internet of Things (IoT) Application Programming Interface (API);
requesting, by the computing device, a plurality of objects in a domain from the IoT API;
extracting, by the computing device, a plurality of names corresponding to the plurality of objects;
pluralizing, by the computing device, each of the plurality of names corresponding to the plurality of objects;
generating, by the computing device, a link for each pluralized name; and
generating, by the computing device, a response to the client device by embedding the link for each pluralized name.

2. The method of claim 1, wherein the link for each pluralized name comprises a link using Hypertext Application Language (HAL) format.

3. The method of claim 2, wherein a rel portion of the link comprises the pluralized name, and wherein a href portion of the link comprises a backslash concatenated with the pluralized name.

4. The method of claim 1, wherein the IoT API is a generic IoT API, and wherein the response to the client device comprises entry points to a domain-specific API.

5. The method of claim 1, further comprising:
joining, by the computing device, the link for each pluralized name in a _links map in the response to the client device.

6. A method comprising:
receiving, by a computing device, a request from a client device to retrieve information corresponding to a particular object from an Internet of Things (IoT) Application Programming Interface (API);
creating, by the computing device, a response map based on the request;
retrieving, by the computing device, a plurality of attributes associated with the particular object from the IoT API;
generating, by the computing device, at least one link corresponding to the particular object; and
generating, by the computing device, a response to the client device by adding the plurality of attributes and the at least one link to the response map.

7. The method of claim 6, further comprising:
determining whether the response includes a collection of objects;
in response to the response including the collection of objects, for each object in the collection:
creating, by the computing device, a response map corresponding to a respective object;
retrieving, by the computing device, a plurality of attributes associated with the respective object from the IoT API;
generating, by the computing device, at least one link corresponding to the respective object; and
adding, by the computing device, the plurality of attributes and the at least one link corresponding to the respective object to the response map.

8. The method of claim 7, further comprising: in response to the response including the collection of objects,
pluralizing, by the computing device, a type name corresponding to the particular object; and
embedding, by the computing device, each response map corresponding to the respective object to the response to the client device using the pluralized type name as a key.

9. The method of claim 6, further comprising:
determining whether the particular object is a thing or a message;
in response to the particular object being the message:
retrieving thing attributes associated with the message from the IoT API; and
adding the thing attributes to the response map.

10. The method of claim 9, wherein adding the thing attributes to the response map further comprising:
determining an object type associated with the message,
adding the thing attributes to the response map using a type name of the object type associated with the message as a key.

11. A method comprising:
receiving, by a computing device, a request from a client device to retrieve information corresponding to a particular relationship from an Internet of Things (IoT) Application Programming Interface (API);
creating, by the computing device, a response map based on the request;
retrieving, by the computing device, a plurality of relationship types associated with the particular relationship from the IoT API;
retrieving, by the computing device, an object type using a respective retrieved relationship type as a target qualifier from the IoT API;
generating, by the computing device, a link object for each object type; and
generating, by the computing device, a response to the client device by adding a plurality of object attributes to the response map, wherein a type name of the each object type is used as a key.

12. The method of claim 11, wherein retrieving the plurality of relationship types associated with the particular relationship from the IoT API further comprises:
retrieving the plurality of relationship types using an object type of an object associated with a respective relationship type as a source qualifier from IoT API.

13. The method of claim 11, further comprising:
determining whether a cardinality of a respective relationship type is many;
in response to the cardinality of the respective relationship type being many, pluralizing the type name of the object type; and
using the pluralized type name as a rel portion in the response to the client device; and
in response to the cardinality of the respective relationship type being one,
using a singular type name as the rel portion in the response to the client device.

14. The method of claim 11, further comprising:
retrieving, by the computing device, a plurality of message types using an object type of a particular object from the IoT API;
for each of the plurality of message types, generating a link object, wherein a rel portion comprises a pluralized name of a respective message type, and wherein a href portion comprises a pluralized name of the respective message type appended to the link; and
adding the link object to the response to the client device.

15. The method of claim 11, further comprising:
retrieving, by the computing device, a plurality of object types using a related object of a particular message from the IoT API;
for each of the plurality of object types, generating a link object, wherein a rel portion comprises a singular name of a respective object type, and wherein a href portion comprises a pluralized name of the respective object type appended to the link; and
adding the link object to the response to the client device.
